(19) United States
(12) Patent Application Publication
(10) Pub. No.: US 2025/0319700 A1
(43) Pub. Date: Oct. 16, 2025

(54) LIQUID EJECTION APPARATUS AND METHOD OF CONTROLLING SAME

(71) Applicant: CANON KABUSHIKI KAISHA, Tokyo (JP)

(72) Inventor: JOJI KATSUURA, Kanagawa (JP)

(21) Appl. No.: 19/097,120

(22) Filed: Apr. 1, 2025

(30) Foreign Application Priority Data
Apr. 16, 2024 (JP) 2024-066205

(51) Int. Cl. B41J 2/165

(52) U.S. Cl. CPC B41J 2/16535; B41J 2/16552; B41J 2002/16558

(57) ABSTRACT

A carriage is movable to a formation position and a wiping position. A wiping mechanism is movable to a standby position, a start position, and an end position. The wiping mechanism is configured to perform the wiping operation by moving from the start position to the end position in a state in which the carriage is at the wiping position after moving from the standby position to the start position. The wiping mechanism performs a preparation operation of preparing the wiping operation at the standby position, and the wiping mechanism performs the preparation operation and movement from the standby position to the start position in parallel to the forming operation when performing the wiping operation following the forming operation.

### BACKGROUND OF THE INVENTION

### Field of the Invention

The present invention relates to a liquid ejection apparatus and a method of controlling the same.

### Description of the Related Art

Some liquid ejection apparatus has a head for ejecting a liquid and form an image by ejecting ink from the head to a recording medium. Some heads have a wiping mechanism for wiping the surface of a head with an ejection opening to recover the performance of ink ejection from the head.

Japanese Patent Application Laid-open No. 2014-108594 discloses a technique in which an ejection surface of a head, where a nozzle is located, is wiped with a cloth wrapped around a pressure roller, and the entire wiping mechanism including a cloth supplier and a recovery roller is moved under the head to wipe the ejection surface of the head.

### SUMMARY OF THE INVENTION

In a liquid ejection apparatus that performs an operation of wiping a head by a wiping mechanism, the time required to perform the wiping operation following a forming operation of ejecting a liquid to an object is shortened.

The present invention is a liquid ejection apparatus comprising:
a head provided with an ejection opening for ejecting a liquid;
a carriage on which the head is mounted; and
a wiping mechanism configured to perform a wiping operation to wipe an ejection surface of the head on which the ejection opening is provided while moving relative to the carriage;
wherein the liquid ejection apparatus is configured to perform a forming operation of ejecting the liquid from the ejection opening to an object while moving the carriage in a main scanning direction with respect to the object,
wherein the carriage is movable to a formation position for performing the forming operation and a wiping position for performing the wiping operation, and
wherein the wiping mechanism is movable to a standby position, a start position at which the wiping operation is started, and an end position at which the wiping operation ends; is configured to perform the wiping operation by moving from the start position to the end position in a state in which the carriage is at the wiping position after moving from the standby position to the start position; performs a preparation operation for preparing the wiping operation in the standby position; and performs the preparation operation and movement from the standby position to the start position in parallel to the forming operation when performing the wiping operation following the forming operation.

Further features of the present invention will become apparent from the following description of exemplary embodiments with reference to the attached drawings.

### BRIEF DESCRIPTION OF THE DRAWINGS

FIG. 1 is a schematic perspective view of a printer from above;

FIG. 2 is a block diagram showing a schematic system configuration;

FIG. 3A is a schematic cross-sectional side view of a wiping mechanism and associated members;

FIG. 3B is a schematic cross-sectional side view of the wiping mechanism and associated members;

FIG. 3C is a schematic cross-sectional side view of the wiping mechanism and associated members;

FIG. 3D is a schematic cross-sectional side view of the wiping mechanism and associated members;

FIGS. 4A to 4I are diagrams of a comparative example in which a printing operation and an operation of the wiping mechanism are not performed in parallel;

FIGS. 5A to 5H are diagrams illustrating a case in which the printing operation and the operation of the wiping mechanism are performed in parallel;

FIGS. 6A to 6G are diagrams illustrating a case in which the printing operation and the operation of the wiping mechanism are performed in parallel and a collision occurs;

FIG. 7 is a flowchart of a reciprocating printing operation;

FIGS. 8A and 8B are graphs showing changes in a carriage speed during the reciprocating printing operation;

FIG. 9 is a diagram of a recording head viewed from a recording medium side; and

FIG. 10 is a diagram showing details of the positional relationship in FIG. 6G.

### DESCRIPTION OF THE EMBODIMENTS

### Example 1

Hereinafter, exemplary embodiments for carrying out the present invention will be described with reference to the drawings. However, the dimensions, materials, shapes, relative arrangement and the like of the components described in the following examples may be modified as appropriate depending on the configuration and various conditions of the device to which the present invention is applied, and are not intended to limit the scope of the present invention to the following examples.

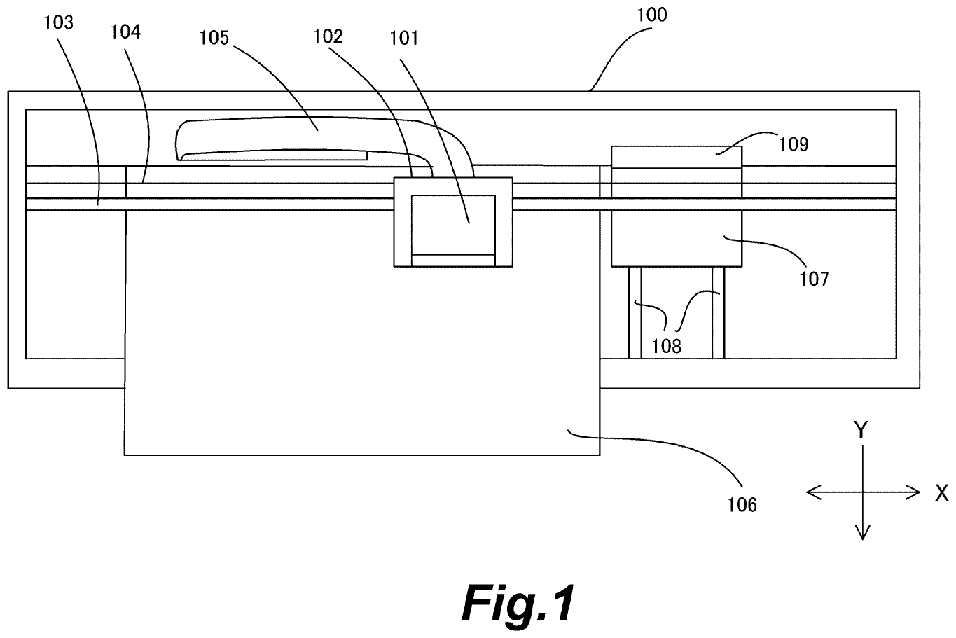

FIG. 1 is a perspective view of a printer 100 according to an embodiment of the present invention from above. A recording head 101 is mounted on a carriage 102, and the carriage 102 moves along a carriage guide shaft 103. The direction in which the carriage 102 moves is called a main scanning direction (X direction in FIG. 1). The current position of the recording head 101 can be detected by an encoder film 104. At the time of printing, a recording medium 106 is fed from the lower part of the printer 100 and is intermittently conveyed. This conveying direction is called a sub-scanning direction (Y direction in FIG. 1). In this embodiment, the main scanning direction and the sub-scanning direction intersect (are orthogonal to each other).

The printer 100 forms an image on the recording medium 106 by repeating conveying of the recording medium 106 in the sub-scanning direction and an image forming operation of ejecting ink from the recording head 101 to the recording medium 106 while moving the carriage 102 in the main scanning direction. The right side in FIG. 1 is called a reference side, the left side is called a non-reference side, forming an image while moving the carriage 102 from the reference side to the non-reference side is called forward printing, and forming an image while moving from the non-reference side to the reference side is called backward printing.

A flexible cable 105 is connected to the recording head 101 via a contact surface in the carriage 102. Signals are exchanged between the recording head 101 and an electric substrate (not shown) through the flexible cable 105. Signals to be exchanged are ejection signals to the recording head 101, and the like.

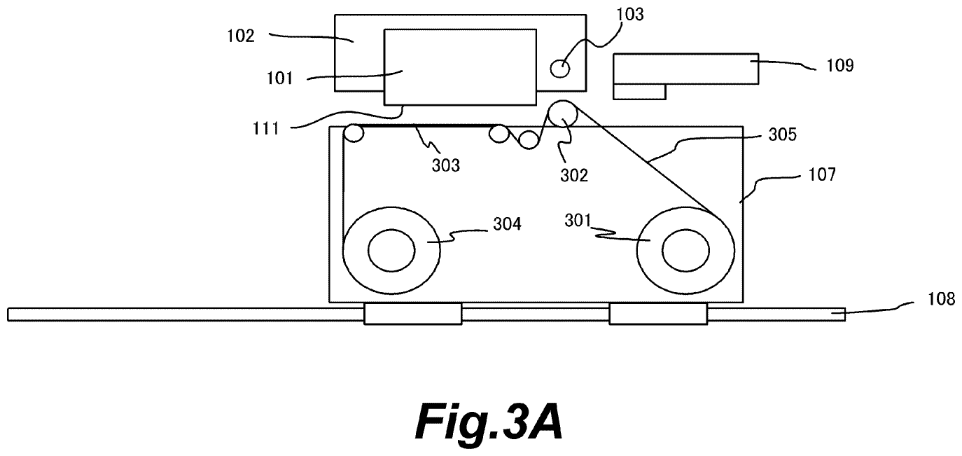

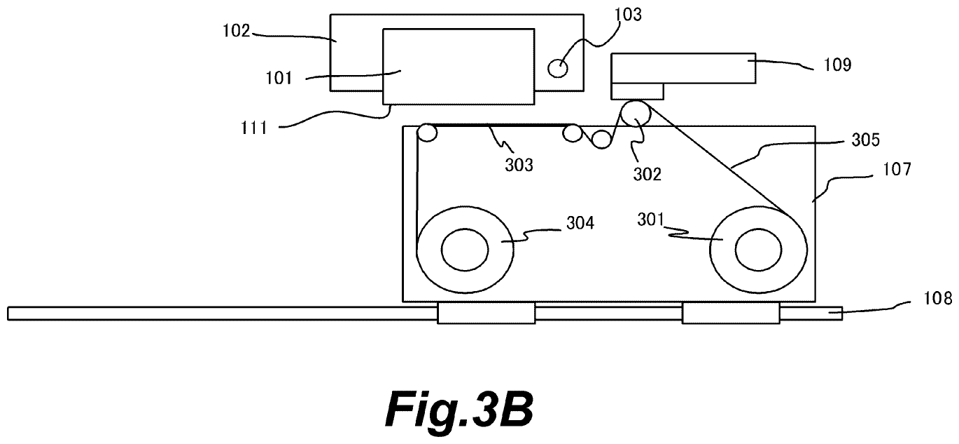

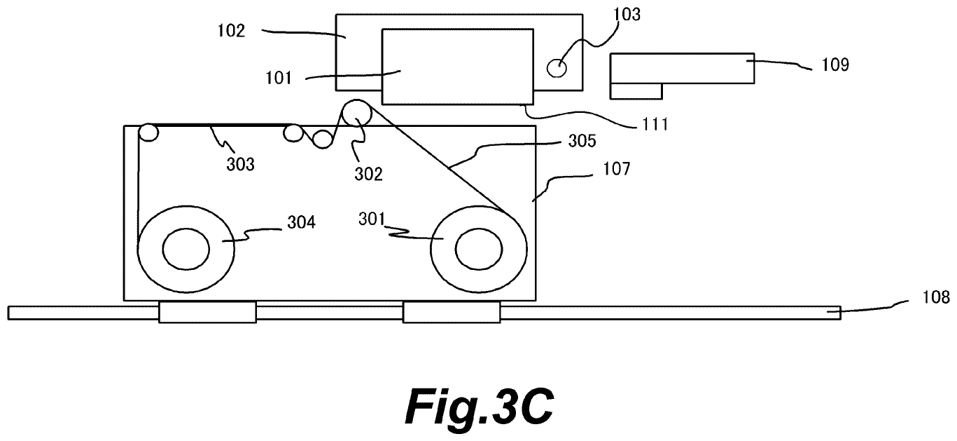

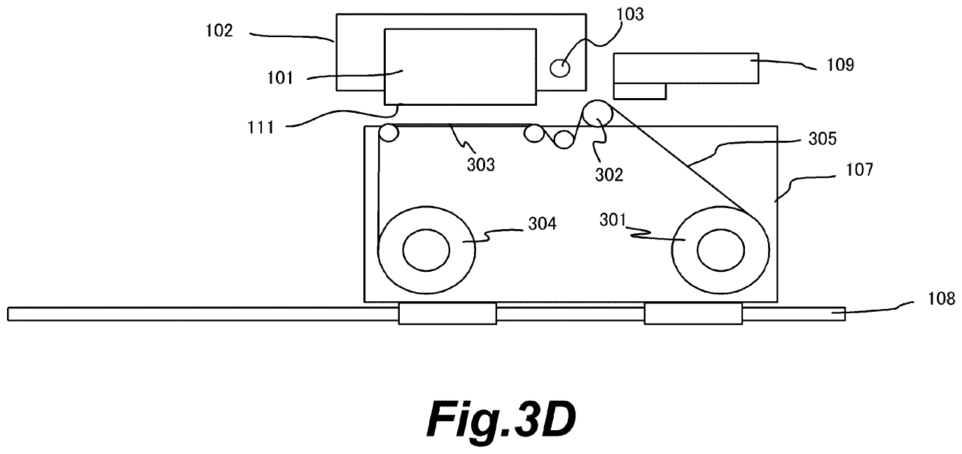

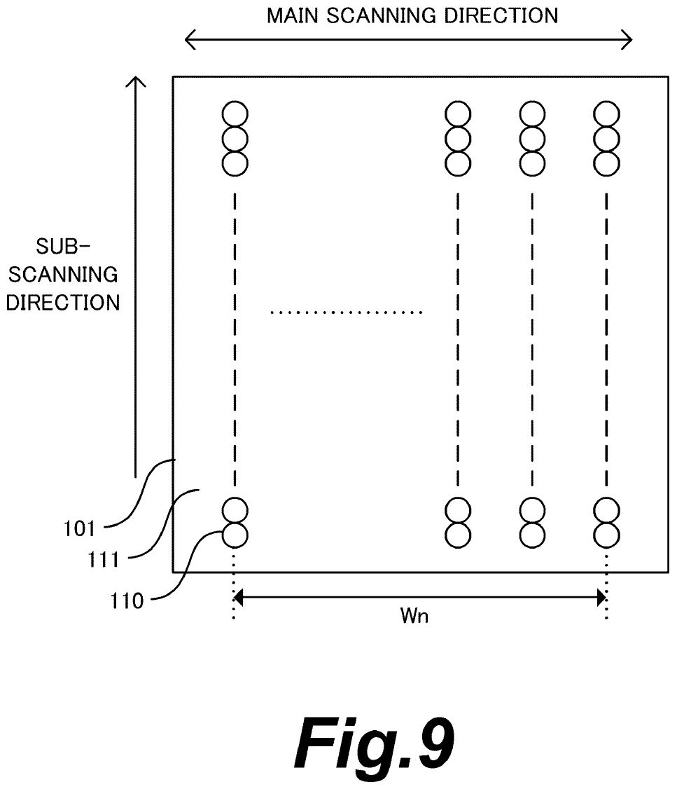

A wiping mechanism 107 is disposed in an area outside of the recording medium 106 to be conveyed and is movable along a wiping mechanism guide shaft 108. Although the detailed operation will be described later, the wiping mechanism 107 is moved along the wiping mechanism guide shaft 108 after the carriage 102 has been moved to the top of the wiping mechanism 107. As a result, the wiping mechanism 107 performs a wiping operation for wiping an ejection surface 111 (refer to FIGS. 3A to 3D and 9) provided with nozzles 110 of the recording head 101 while moving relative to the carriage 102.

That is, the carriage 102 is movable between an image forming position for performing an image forming operation in which ink is ejected onto the recording medium 106, and a wiping position for performing a wiping operation. Here, the image forming position refers to a range in the main scanning direction in which the carriage 102 moves in forward printing and backward printing. The wiping position refers to the position of the carriage 102 which allows the wiping mechanism 107 to perform a wiping operation on the recording head 101. Accordingly, depending on the configuration of the printer 100, there may be a case in which the carriage 102 is located at a position (referred to as a process position) where the image forming operation is not performed and the wiping operation is also not performed in the process of movement from the image forming position to the wiping position. Referring to the carriage 102 being movable to the image forming position and the wiping position includes the carriage 102 being movable to the process position.

A cleaning solution application mechanism 109 is disposed above the wiping mechanism 107, and is capable of applying a cleaning solution to a sheet on the wiping mechanism 107 before wiping. Details will be described later.

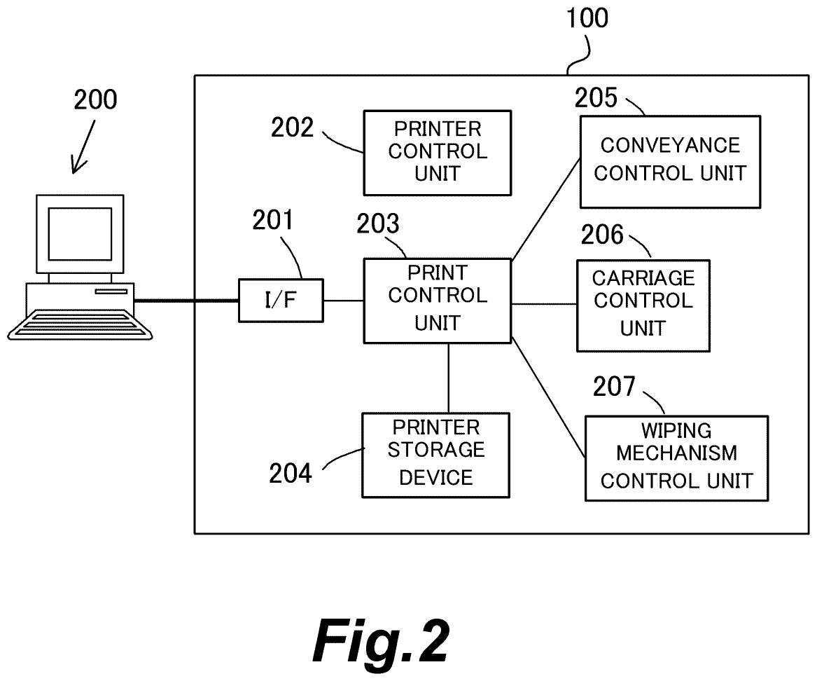

FIG. 2 is a block diagram showing a schematic configuration of a system according to an example of the present invention. Print data is transmitted from a host 200 to the printer 100. A printer control unit 202 controls the entire processing in the printer 100. An I/F 201 receives the print data from the host 200. The print control unit 203 stores the print data in a printer storage device 204. The print control unit 203 determines a printing method depending on the print data sent from the host and information associated with the print data. The printing method also includes a carriage movement width and a printing mode. The print control unit 203 repeats conveying of the recording medium 106 using a conveyance control unit 205 and movement of the carriage 102 using a carriage control unit 206 in accordance with the determined printing method to form an image.

In order to prevent the ink ejection performance from being degraded, the wiping mechanism 107 is moved using a wiping mechanism control unit 207 to wipe the ejection surface 111 of the recording head 101. Thus, the ink adhered to the ejection surface 111 can be wiped off. Although the timings of wiping are determined by the characteristics of the ink and the amount of ink ejected, there is a possibility of timings occurring when wiping during image formation is required. The timing (frequency) of wiping can be, for example, wiping periodically, such as once every five minutes. The interval of wiping may vary depending on the characteristics of the ink and the head temperature, for example, between 2 minutes and 20 minutes.

FIGS. 3A to 3D are schematic cross-sectional side views of the wiping mechanism and related mechanisms according to an embodiment of the present invention. The carriage 102 carries the recording head 101 and moves along a carriage guide shaft 103. As a result, the recording head 101 is movable in the main scanning direction (backward or forward in FIGS. 3A to 3D). A plurality of liquid ejection openings is provided on the lower surface (ejection surface 111) of the recording head 101 to eject ink.

The wiping mechanism 107 has a sheet 305, which is an absorption member capable of absorbing ink, thereinside, and can wipe off the ink from the ejection surface 111 by pressing the sheet 305 against the ejection surface 111 of the recording head 101. The wiping mechanism 107 supplies a new sheet 305 from a sheet supply mechanism 301. A wiping part 302 presses the sheet 305 supplied from the sheet supply mechanism 301 against the ejection surface 111 of the recording head 101 to perform wiping. In order to perform pressing, the wiping part 302 has a structure protruding above the ejection surface 111 of the recording head 101.

A preliminary ejection receiving surface 303 is a receiving part for receiving ink at the time of ink ejection (hereinafter referred to as preliminary ejection) in order to recover the performance of ejection from the recording head 101, and is a surface allowing the sheet 305 to be exposed to the outside of the wiping mechanism 107. The sheet 305 to which the ink is adhered is wound by a sheet winding mechanism 304, and thus the sheet 305 to which the ink is not adhered is supplied from the sheet supply mechanism 301 to the wiping part 302 and the preliminary ejection receiving surface 303. The entire wiping mechanism 107 can be moved along the wiping mechanism guide shaft 108.

The cleaning solution application mechanism 109 is an application member for applying a cleaning solution to the sheet 305 on the wiping part 302 before the wiping part 302 wipes the ejection surface 111 of the recording head 101. The sheet 305 is made of a material capable of absorbing a liquid, such as a cloth. Further, the operation of wiping off the ink adhered to the ejection surface 111 is not limited to absorption of a liquid by pressing the sheet 305 against the ejection surface 111, and may be wiping by moving a blade-shaped member (blade wiper) in contact with the ejection surface 111.

Application of the cleaning solution to the sheet 305 by the cleaning solution application mechanism 109 may be performed each time the wiping operation is performed, or may be performed independently at a timing different from the timing of performing the wiping operation. In a case where the cleaning solution is applied each time the wiping operation is performed, the preparation operation for the wiping operation may include the operation of applying the cleaning solution to the sheet 305. If it is necessary to wait for the cleaning solution to penetrate the sheet 305 for a certain period of time after the cleaning solution is applied to the sheet 305, by performing the application at a timing separate from execution of the wiping operation, the time required for execution of the wiping operation can be reduced.

A series of wiping operations will be described in detail below. FIG. 3A shows a state in which the wiping mechanism 107 is in a standby position. When the wiping mechanism 107 is not performing a wiping-related operation, the wiping mechanism 107 is in the standby position. When the wiping mechanism 107 is in the standby position, even if the carriage 102 is moved above the wiping mechanism 107, the carriage 102 does not collide with the wiping mechanism 107.

Prior to the wiping operation, the wiping mechanism 107 is moved from the standby position in FIG. 3A to a cleaning solution application position in FIG. 3B. In a state in which the wiping mechanism 107 is located at the cleaning solution application position, the cleaning solution application mechanism 109 applies the cleaning solution to the sheet on the wiping part 302. Even when the wiping mechanism 107 is in the cleaning solution application position or the carriage 102 is moved above the wiping mechanism 107, the wiping mechanism 107 and the carriage 102 do not collide with each other. Accordingly, the position shown in FIG. 3A and the cleaning solution application position can be collectively referred to as the standby position of the wiping mechanism 107. In this case, if the cleaning solution is applied as a preparation operation for the wiping operation, the wiping mechanism 107 may also perform the preparation operation in the standby position.

Once application of the cleaning solution is completed, the wiping mechanism 107 is moved from the cleaning solution application position shown in FIG. 3A to a start position (pre-wiping standby position) at which the wiping operation is started, shown in FIG. 3C. During the movement, the carriage 102 is moved in a state in which it is not positioned above the wiping mechanism 107 (wiping position) such that the ejection surface 111 of the recording head 101 is not wiped by the wiping part 302. The reason why the wiping operation is not performed at the time of movement from the standby position (cleaning solution application position) in FIG. 3B to the start position in FIG. 3C is as follows. This is because it is desirable to remove the ink that has entered the inside of the ejection openings immediately after wiping through preliminary ejection, but in the state of FIG. 3C, the preliminary ejection receiving surface 303 does not face the bottom of the recording head 101 and the preliminary ejection cannot be performed.

In a state in which the wiping mechanism 107 is in the start position in FIG. 3C, the carriage 102 is moved to the wiping position above the wiping mechanism 107, and then the wiping operation is started. The wiping mechanism 107 moves from the start position in FIG. 3C to an end position at which the wiping operation ends in FIG. 3D, thereby wiping the ejection surface 111 of the recording head 101 with the wiping part 302. After the wiping operation ends, the recording head 101 performs preliminary ejection at the end position shown in FIG. 3D in order to remove the ink that has entered the inside of the ejection opening as described above. Accordingly, the end position of the wiping operation can also be referred to as a preliminary ejection position at which the recording head 101 performs preliminary ejection. The ink at the time of preliminary ejection is absorbed by the sheet 305 of the preliminary ejection receiving surface 303. After preliminary ejection, the sheet 305 stained with the ink is wound up by using the sheet winding mechanism 304, and the sheet 305 returns to the standby position shown in FIG. 3A. This completes the series of wiping operations.

The printer 100 of the present example characterized in that the wiping mechanism 107 moves from the standby position to the start position in parallel with the printing operation of the recording head 101 when the wiping operation is performed following the printing operation (image forming operation). Further, when performing the preparation operation at the standby position, the wiping mechanism 107 performs the preparation operation of the wiping mechanism 107 and movement from the standby position to the start position in parallel with the printing operation of the recording head 101. In order to make the features of the present example easier to understand, a comparative example in which the wiping mechanism 107 is not moved from the standby position to the start position in parallel with the printing operation when the wiping operation is performed following the printing operation will be described.

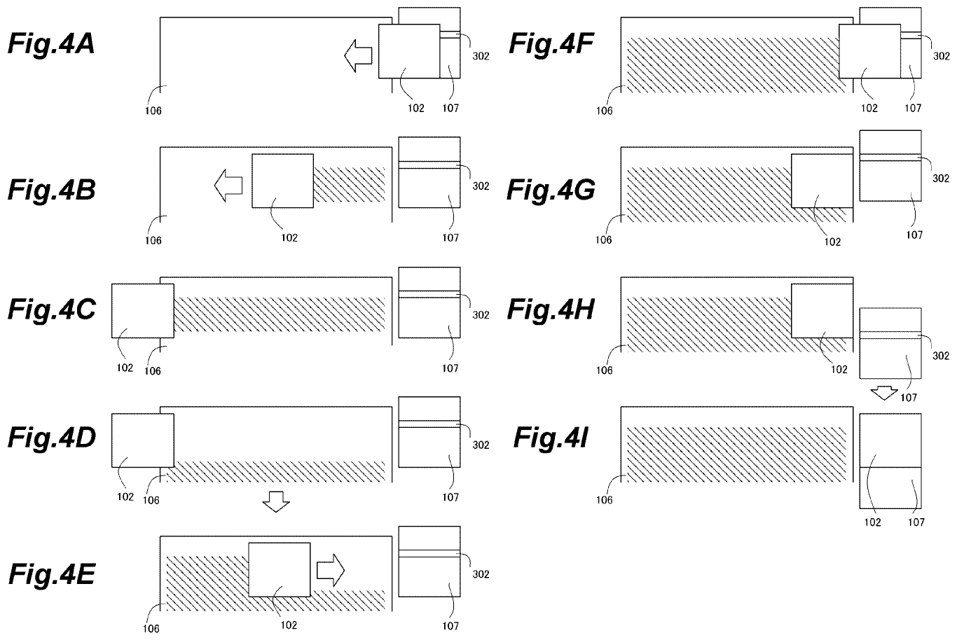

FIGS. 4A to 4I are diagrams for describing the comparative example in which the printing operation and the wiping operation of the wiping mechanism 107 are not performed in parallel. FIGS. 4A to 4I are schematic diagrams of the printer 100 as viewed from above, showing operations of forward printing, conveying of the recording medium 106, backward printing, and completion of preparation for the wiping operation in chronological order.

FIG. 4A shows a positional relationship between the carriage 102 and the wiping mechanism 107 when forward printing is started. The wiping mechanism 107 is in the standby position. In order to form an image near the reference side of the recording medium 106, a part of the carriage 102 needs to be above the wiping mechanism 107. At the standby position, the wiping part 302 on the wiping mechanism 107 does not collide with the recording head 101 (refer to FIG. 3A). FIG. 4B shows a state in which the forward printing ends in FIG. 4C during the forward printing. FIG. 4D shows the timing at which backward printing is started after the recording medium 106 is moved in the sub-scanning direction. FIG. 4E shows a state in which the backward printing is completed in FIG. 4F during the backward printing.

From FIG. 4A to FIG. 4F, the wiping mechanism 107 remains at the standby position and does not move at all. In order to move the wiping mechanism 107 to the start position from the state shown in FIG. 4F, the carriage 102 needs to be once retracted from above the wiping mechanism 107. FIG. 4G shows the time when the carriage 102 has been retracted (moved in the forward direction) and the wiping mechanism 107 has been moved to the cleaning solution application position (refer to FIG. 3B). FIG. 4H shows movement of the wiping mechanism 107 to the start position, and FIG. 4I shows movement of the carriage 102 in the backward direction over the wiping mechanism 107 moved to the start position. At the start position, the wiping part 302 on the wiping mechanism 107 does not collide with the recording head 101 (refer to FIG. 3C). Thereafter, the wiping operation by the wiping mechanism 107 becomes possible.

Here, when an image is formed in an area exceeding the size of the recording head 101 in the sub-scanning direction (the width of an image in the sub-scanning direction that can be formed by one forward printing or backward printing), the forward printing, the backward printing, and the conveying operation of the recording medium in the sub-scanning direction are repeated a plurality of times. A case in which the wiping operation is performed following at least one of a plurality of times of reciprocating printing (image forming operations) is conceivable when a plurality of times of reciprocating printing are performed in order to form an image on such a wide area of the recording medium. In this case, as described in FIGS. 4A to 4I, when the carriage 102 is retracted and the wiping mechanism 107 is moved after the backward printing ends, the throughput of printing is reduced by the amount of time.

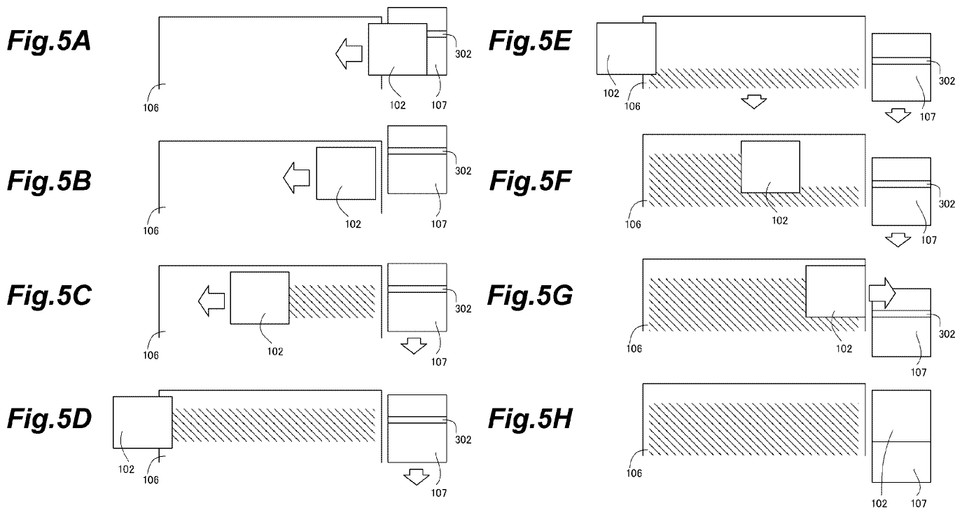

FIGS. 5A to 5H are diagrams showing a case in which a printing operation and the operation of the wiping mechanism 107 are performed in parallel. Similarly to FIGS. 4A to 4I, operations until preparation for wiping is completed are shown in chronological order.

FIG. 5A shows the positional relationship between the carriage 102 and the wiping mechanism 107 when forward printing is started, similarly to FIG. 4A. FIG. 5B shows a state in which the wiping mechanism 107 is moving to the cleaning solution application position in parallel with the movement of the carriage 102 for forward printing. Even if the carriage 102 moves above the wiping mechanism 107 while the wiping mechanism 107 is moving to the cleaning solution application position, there is no collision member and thus there is no problem (refer to FIG. 3B). FIG. 5C shows a state in which the wiping mechanism 107 starts moving to the start position in parallel with the operation of the carriage 102 during the forward printing. FIG. 5D shows a state where the forward printing ends. FIG. 5E shows the timing at which the recording medium 106 is moved in the sub-scanning direction and backward printing is started. FIG. 5F shows a state during backward printing. FIG. 5G also shows the timing during backward printing, immediately before the carriage 102 moves onto the wiping mechanism 107.

Here, the wiping mechanism 107 continues to move to the start position (refer to FIG. 3C) between FIG. 5C and FIG. 5G. As a result, the wiping mechanism 107 has reached the start position at the time of FIG. 5G, and in this state, the carriage 102 can be moved onto the wiping mechanism 107 continuously with the backward printing operation (FIG. 5H). Thereafter, a wiping operation is performed by the wiping mechanism 107. With this operation, retraction of the carriage 102 in FIG. 4G is not required, and the time of movement of the wiping mechanism 107 to the start position is included in the time of the printing operation. Accordingly, throughput reduction of printing can be curbed.

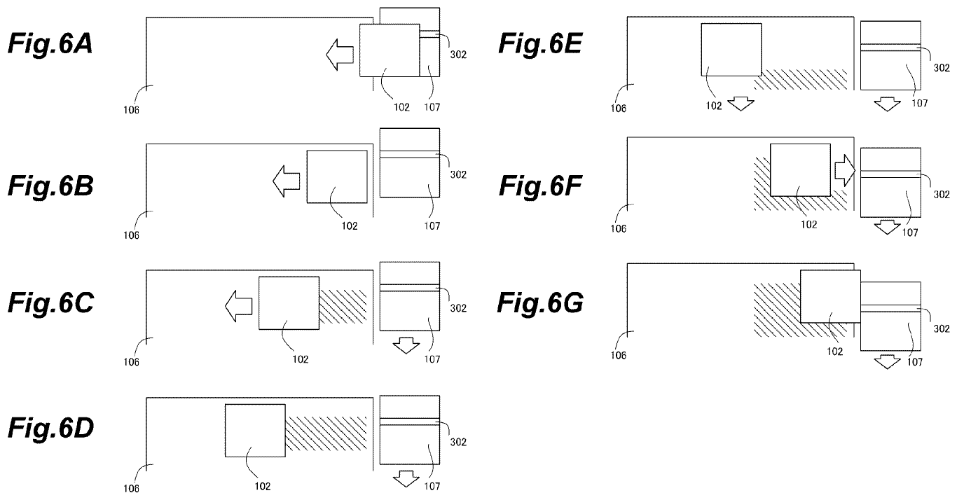

FIGS. 6A to 6G are diagrams showing a case in which a printing operation and the operation of the wiping mechanism 107 are performed in parallel and a collision occurs. FIGS. 6A and 6B show the same operations as those shown in FIGS. 5A and 5B. FIG. 6C shows a state during forward printing, and FIG. 6D shows a state after forward printing ends. A difference from FIGS. 5A to 5H is that the width of a print image in the sub-scanning direction is narrow. FIG. 6E shows the timing at which backward printing is started after the recording medium 106 is moved in the sub-scanning direction. FIG. 6F shows a state during the backward printing.

Similarly to FIGS. 5A to 5H, the wiping mechanism 107 is moved in parallel with the printing operation. However, in the case of FIGS. 6A to 6G, since the width of a print image is narrow, the printing operation time is short, and the carriage 102 tries to move over the wiping mechanism 107 before the wiping mechanism 107 reaches the start position. As a result, the state shown in FIG. 6G is obtained, and the wiping part 302 on the wiping mechanism 107 and the recording head 101 are brought into collision with each other because the wiping part 302 projects above the ejection surface of the recording head 101.

In this manner, the printer 100 of the present example is configured such that, when the wiping mechanism 107 is in a position halfway between the standby position and the start position, the carriage 102 can collide with the wiping mechanism 107 at a predetermined collision position during the printing operation (i.e., when it is at the image formation position). Therefore, in order to avoid a collision, adjustment is performed to increase the time required for the printing operation such that the carriage 102 reaches a collision position after the wiping mechanism 107 reaches the start position.

The adjustment can be performed, for example, by making the range of movement of the carriage 102 in the main scanning direction greater than a predetermined range of movement. In the case of an image forming operation (recording operation) for forming an image on a recording medium 106 with ink, the predetermined range of movement of the carriage 102 is a range of movement determined by the width of an image to be recorded in the main scanning direction.

Further, the adjustment can be performed, for example, by changing predetermined parameters regarding a speed of movement of the carriage 102 to increase the time required for the carriage 102 to move through a predetermined range of movement in the main scanning direction. In the case of an image forming operation, the predetermined parameters regarding the speed of movement of the carriage 102 are, for example, parameters set depending on a recording mode (printing mode) regarding quality or speed of recording of an image. Such parameters include a speed when the carriage 102 moves at a constant speed. In this case, the adjustment can be performed by decreasing the speed of the constant speed movement of the carriage 102 from a predetermined speed.

Further, the adjustment can be performed by, for example, providing a stop period during which ink is not ejected during an image forming operation.

The adjustment may also be performed by combining increasing the range of movement of the carriage 102, changing parameters regarding the speed of movement, and providing a stop period.

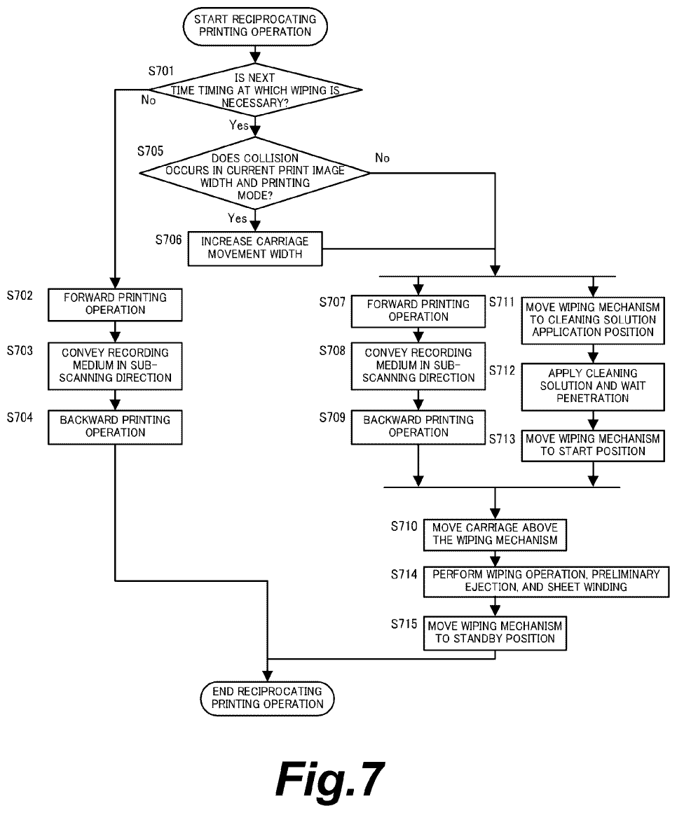

FIG. 7 is a flowchart showing a reciprocating printing operation according to an embodiment of the present invention. The reciprocating printing operation is to handle forward printing and backward printing together with accompanying operations. The flowchart of FIG. 7 is executed by the print control unit 203. Hardware operations in the flowchart of FIG. 7 are executed by the conveyance control unit 205, the carriage control unit 206, and the wiping mechanism control unit 207 in response to an instruction from the print control unit 203.

When the reciprocating printing operation is started, it is determined whether wiping is required after forward printing and backward printing performed from now (step S701). For example, when a cumulative ejection amount of ink after the previous execution of the wiping operation reaches a threshold value or more, it is determined that the wiping operation is required. It is also possible to determine that the wiping operation is required when a predetermined time has elapsed since the previous execution of the wiping operation.

If the determination in the step S701 is No, a forward printing operation is performed (step S702), a recording medium is conveyed in the sub-scanning direction (step S703), a backward printing operation is performed (step S704), and the reciprocating printing operation is ended.

If the determination in step S701 is Yes, it is determined whether or not a collision (the situation of FIG. 6G) occurs when the carriage 102 is moved above the wiping mechanism 107 in the current print image width and printing mode (step S705). The printing mode (recording mode) is, for example, a value determined by a user designating “good,” “normal,” or “fast” as the image quality, in combination with the designated image quality and the type of recording medium. Depending on the printing mode, the speed of the carriage 102 during printing and the amount of conveyance of the recording medium 106 in the sub-scanning direction are determined. Details of the determination method in step S705 will be described later.

If the determination in step S705 is Yes, movement width setting of the carriage is increased such that no collision occurs (step S706). This will also be described in detail later. Thereafter, the printing operation and the operation of the wiping mechanism 107 are performed in parallel.

If the determination in step S705 is No, printing and the operation of the wiping mechanism 107 are performed in parallel in a state in which the setting is not changed. In the printing operation, a forward printing operation (step S707), conveying a recording medium in the sub-scanning direction (step S708), and a backward printing operation (step S709) are performed in this order. In the forward printing operation (step S707) and the backward printing operation (step S709), when the carriage movement width setting is increased in processing of step S706, the carriage is moved accordingly.

The operation of the wiping mechanism 107 performed in parallel with the printing operation includes moving to the cleaning solution application position (step S711), applying the cleaning solution and waiting for penetration (step S712), and starting moving to the start position (step S713). Although an example in which the cleaning solution application operation of steps S711 and S712 is performed as a preparation operation for the wiping operation is shown here, the cleaning solution application operation may not be included in the preparation operation for the wiping operation as described above. In this case, the cleaning solution application operation may be performed at another timing, for example, during a reciprocating printing operation in which wiping is not required, and the processing of steps S711 and S712 may be omitted in the wiping operation. In this case, movement processing (step S713) for the wiping operation can be performed in parallel with the processing of step S707 in the image forming operation. In this case, in order to avoid a collision between the wiping part 302 and the recording head 101, after waiting for the carriage 102 to move to a position not above the wiping mechanism 107, movement processing for the wiping operation (step S713) is performed.

The carriage 102 is moved above the wiping mechanism 107 continuously from the backward printing operation in step S709 (step S710). Even if it is determined that a collision occurs in step S705, the wiping mechanism 107 has reached the start position before the carriage 102 passes over the wiping mechanism 107 according to adjustment processing in step S706. Therefore, the carriage 102 can be moved above the wiping mechanism 107 without collision between the recording head 101 and the wiping part 302.

After step S710, an actual wiping operation is performed by moving the wiping mechanism 107 under the carriage 102, and after preliminary ejection is performed, the sheet to which the ink is adhered is wound (step S714). Thereafter, the wiping mechanism 107 is moved to the standby position (step S715), and the reciprocating printing operation ends.

In this manner, in the method of controlling the reciprocating printing operation in the present example, the wiping mechanism 107 is first caused to wait at the standby position. Next, the image forming operation and the operation of moving the wiping mechanism 107 from the standby position to the start position are performed in parallel. Next, following the image forming operation, the carriage 102 is moved to a wiping position at which the wiping operation is performed by the wiping mechanism 107. Next, in a case in which the carriage 102 is at the wiping position, the wiping mechanism 107 is moved from the start position to the end position at which the wiping operation will end, thereby wiping the ejection surface 111 of the recording head 101. In a case in which the carriage 102 reaches a collision position before the wiping mechanism 107 reaches the start position, adjustment for increasing the time required for the image forming operation is performed, and movement of the wiping mechanism 107 is performed in parallel with the image forming operation with the setting in which the wiping mechanism 107 does not collide with the carriage 102.

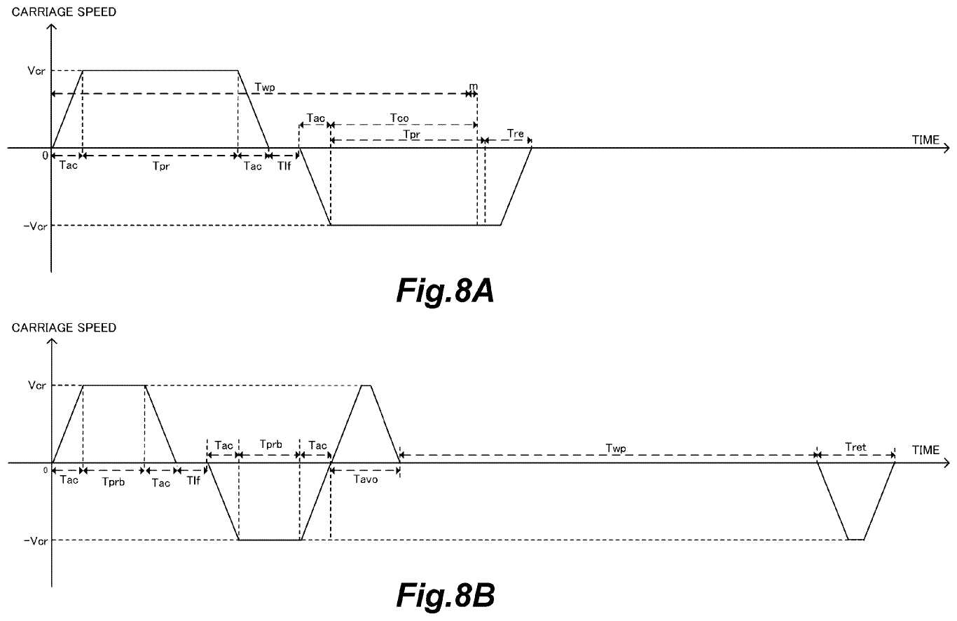

Details of the processing of steps S705 and S706 in FIG. 7 will be described. FIGS. 8A and 8B are graphs showing changes in the carriage speed during the reciprocating printing operation. In FIGS. 8A and 8B, the vertical axis represents the carriage speed and the horizontal axis represents the time. The carriage speed at the time of forward printing is set to a positive value, and the carriage speed at the time of backward printing is set to a negative value. The carriage speed Vor is a value determined by the printing mode. FIG. 8A is a graph corresponding to a case in which the printing operation of FIGS. 5A to 5H and the operation of the wiping mechanism 107 are performed in parallel, and FIG. 8B is a graph corresponding to a case in which the printing operation of FIGS. 4A to 4I and the operation of the wiping mechanism 107 are not performed in parallel.

The time on the horizontal axis in FIG. 8A will be described. The time required to accelerate the carriage speed to Ver is Tac. It is assumed that the time during which the carriage speed reaches the constant speed Ver is Tpr, and printing (ink ejection operation) is performed during this period. The time required for deceleration after forward printing is finished is Tac on the assumption that the acceleration and the deceleration are identical. The time required for the recording medium to move in the sub-scanning direction is Tlf. Tlf is also a value determined by the printing mode.

Although the carriage speed becomes a negative value at the time of backward printing, acceleration and constant speed movement are performed in the same manner as in forward printing. However, after printing ends, the carriage is continuously moved above the wiping mechanism 107, and thus the time required to stop is Tre, which is greater than the deceleration time Tac at the time of forward printing. Here, the time required for the recording head 101 to move to a position (refer to FIG. 6G) where the recording head 101 may collide with the wiping mechanism 107 after movement for backward printing at a constant speed is Tco is started.

The condition in which the wiping mechanism 107 does not collide with the carriage 102 is represented by the following Expression 1, where the time required for the wiping mechanism 107 to move to the start position (the time from step S711 to step S713 in FIG. 7) is Twp.

$$Tpr + 3 Tac + Tlf + Tco \geq Twp + m \qquad ( Expression 1 )$$

In Expression 1, m is a margin considering various errors. In step S705 in FIG. 7, No is determined if Expression 1 is satisfied, and Yes is determined if Expression 1 is not satisfied. The left side of Expression 1 is a value obtained by the printing mode and the image width. FIG. 8A shows Twp and m when the following expression is satisfied.

$$Tpr + 3 Tac + Tlf + Tco = Twp + m .$$

The method of calculating Tpr, Tac, and Tco will be described. The carriage speed determined by the printing mode is represented by Vcr, and the image width determined by image data is represented by Wp. FIG. 9 is a diagram showing the recording head 101 viewed from the side of the recording medium 106. The ejection surface 111 of the recording head 101 is provided with nozzles 110, which are ink ejection openings arranged in the sub-scanning direction, and this is called a nozzle row. A plurality of nozzle rows is present in the main scanning direction, and inks of different colors are ejected from the nozzles 110 of each nozzle row.

In this manner, the ejection surface 111 of the recording head 101 is provided with rows of nozzles for ejecting inks of different colors which are arranged in the main scanning direction. Accordingly, it is desirable that the direction in which the wiping mechanism 107 wipes the ejection surface 111 in the wiping operation be not parallel to the main scanning direction in order to curb mixing of inks of different colors due to the wiping operation. In the present embodiment, as shown in FIGS. 3A to 3D, the direction of movement of the wiping mechanism 107 is parallel to the sub-scanning direction which intersects the main scanning direction (which is orthogonal to the main scanning direction in the present example). Accordingly, the inks of different colors are less likely to be mixed due to the wiping operation.

When the image forming operation is performed, it is necessary to bring ink nozzle rows of the colors used for image formation to a position above an image end on the recording medium 106. The distance in the main scanning direction between the nozzle row on the most non-reference side and the nozzle row on the most reference side which will be used for image formation on the recording medium 106 is denoted as Wn. For example, when image formation is performed using all nozzle rows of the recording head 101, it is necessary to move the carriage 102 not only by the image width Wp but also by the distance Wn. For this reason, the Tpr is obtained by the following expression.

$$Tpr = ( Wp + Wn ) / Vcr$$

When the acceleration of the carriage 102 is a (the deceleration is also a), Tac is obtained by the following expression.

$$Tac = Vcr / a$$

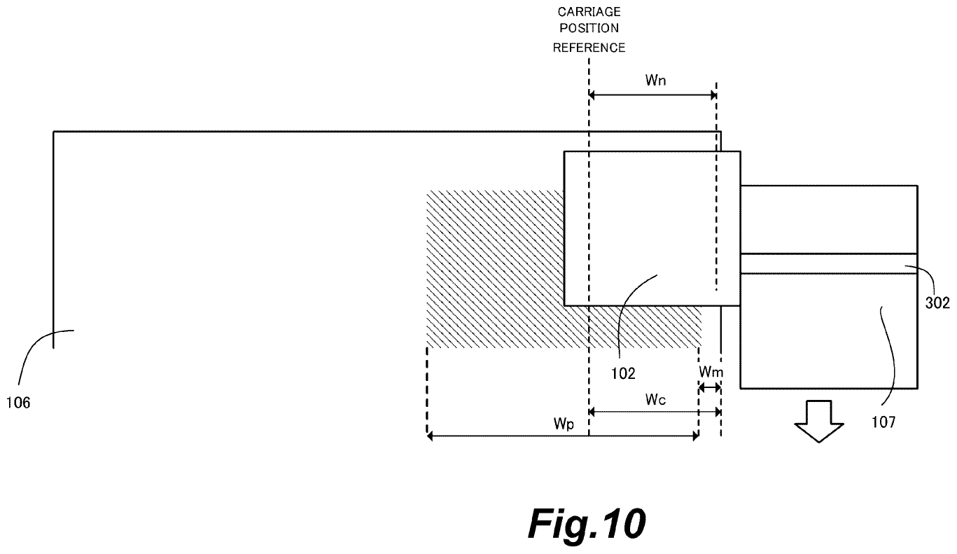

The position where the recording head 101 and the wiping mechanism 107 are brought into collision with each other in FIG. 6G is a fixed position. FIG. 10 is a diagram showing the positional relationship shown in FIG. 6G in detail. The position of the carriage 102 is based on the position of the nozzle row on the most non-reference side. The distance between the position where the collision occurs and the reference side end of the recording medium 106 is Wc. If the margin to the image on the reference side is Wm, Tco can be calculated by the following expression.

$$Tco = ( ( Wp + Wm - Wc ) + Wn ) / Vcr$$

Putting each value into Expression 1 results in the following expression.

$$( Wp + Wn ) / Vcr + 3 Vcr / a + Tlf + ( ( Wp + Wm - Wc ) + Wn ) / Vcr \geq Twp + m$$

The processing of step S706 in FIG. 7 will be described. If Expression 1 is not satisfied, the image width Wp is replaced with a value Wrp that satisfies Expression 1, and the carriage is moved to pass through the range of Wrp. That is, Wrp which satisfies the following expression is set.

$$( Wrp + Wn ) / Vcr + 3 Vcr / a + Tlf + ( ( Wrp + Wm - Wc ) + Wn ) / Vcr \geq Twp + m$$

The above expression is modified to obtain the following expression.

$$\begin{matrix}( 2 Wrp + 2 Wn + Wm - Wc ) / Vcr \geq Twp - 3 Vcr / a - Tlf + m \\ Wrp \geq ( Vcr ( Twp - 3 Vcr / a - Tlf + m ) - 2 Wn - Wm + Wc ) / 2\end{matrix}$$

FIG. 8A shows the result after adjusting the above expression such that the expression is satisfied.

FIG. 8B is a graph showing a case in which the operation of the wiping mechanism 107 is performed after the printing operation shown in FIGS. 4A to 4I ends without adjusting the image width Wp. The time on FIG. 8B will be described. Tac and Tlf are the same as in FIG. 8A. The time corresponding to Tpr in FIG. 8A is Tprb in FIG. 8B because the image width Wp is not adjusted. Further, unlike FIG. 8A, the time required for the deceleration of the carriage 102 is Tac because the carriage 102 does not move continuously above the wiping mechanism 107 after completion of printing at the time of backward printing.

The time taken to retract the carriage 102 from above the wiping mechanism 107 (refer to FIGS. 4F and 4G) after printing is completed is set to Tavo. After the carriage 102 is retracted, the time Twp required to move the wiping mechanism 107 to the start position is required. Thereafter, the time taken to move the carriage 102 above the wiping mechanism 107 (refer to FIG. 4H and FIG. 4J) is set to Tret.

The time in FIG. 8A is compared to the time in FIG. 8B. If the time until the wiping operation can start is Tready_a in FIG. 8A and Tready_b in FIG. 8B, then they are represented by the following expressions.

$$\begin{matrix}Tready\_a = Twp + m + ( Tpr - Tco ) + Tre \\ Tready\_b = 4 Tac + 2 Tprb + Tlf + Tavo + Twp + Tret\end{matrix}$$

In FIG. 8B, the carriage speed when the carriage 102 is retracted and moved above the wiping mechanism 107 is made equal to the speed at the time of printing, but in this case, the following expression is satisfied.

$$Tret > m + ( Tpr - Tco ) + Tre$$

This is because Tret includes the acceleration time of the carriage 102. For this reason, the following expression is satisfied.

$$Tready\_b > Twp + Tret > Twp + m + ( Tpr - Tco ) + Tre = Tready\_a$$

Accordingly, the following expression is always satisfied.

$$Tready\_b > Tready\_a$$

That is, when the printing operation and the operation of the wiping mechanism 107 are performed in parallel, the time until the wiping operation can be started is shorter.

It is possible to shorten the time Tavo and the time Tret by making the carriage speed when the carriage 102 is retracted and moved above the wiping mechanism 107 faster than the speed at the time of printing. In this case, the following expression is usually satisfied.

$$( Time required for forward printing and backward printing ) > m + ( Tpr - Tco ) + Tre$$

That is, the following expression is satisfied.

$$4 Trac + 2 Tprb + Tlf > m + ( Tpr - Tco ) + Tre$$

Accordingly, the following expression is satisfied.

$$Tready\_b > Tready\_a$$

In FIGS. 8A and 8B, carriage movement in forward printing is stopped, and then the recording medium is moved in the sub-scanning direction, and after the movement is completed, backward printing is started. To improve the throughput, the operations during deceleration of forward printing and during acceleration of backward printing without ejecting ink and the movement of the recording medium in the sub-scanning direction may be operated in parallel. In this case, the time required for the parallel operations may be subtracted from Tlf. Further, for the sake of simplicity, ink is ejected in an interval in which the carriage speed is a constant speed Vor in FIGS. 8A and 8B, but ink may be ejected during acceleration and deceleration. Furthermore, an acceleration and a deceleration may be changed during acceleration and deceleration.

Further, although the carriage speed is changed in a trapezoidal form in FIGS. 8A and 8B, the carriage speed may be gently changed by taking a moving average in order to avoid sudden changes in the speed. In such cases, the basic concept is the same, and calculation described so far is possible because the area of the graph in FIGS. 8A and 8B is the moving distance. In contrast to such cases, Expression 1 may be used simply by taking into account a calculation error in the margin m, although it is not an accurate value.

As described above, according to example 1, in the liquid ejection apparatus that performs a head wiping operation using the wiping mechanism, the time required to perform the wiping operation following a forming operation of ejecting a liquid to an object (recording medium) can be shortened. The time required for one scan can be prevented from largely varying for each scan, and as a result, color unevenness between scans in an image can be reduced.

### Example 2

In example 2, the carriage speed is changed to a different carriage speed from the carriage speed determined by the printing mode, although movement width setting of the carriage is increased in step S706 of FIG. 7 in example 1. When the changed carriage speed is assumed to be Vrcr, the following expression may be satisfied.

$$( Wp + Wn ) / Vrcr + 3 Vrcr / a + Tlf + ( ( Wp + Wm - Wc ) + Wn ) / Vrcr \geq Twp + m$$

The carriage speed during printing is usually set to one of a plurality of predetermined values rather than to an arbitrary value. Vrer applicable to the above expression is obtained, used as the carriage speed at the time of forward printing and backward printing, and applied to the processing of steps S707 and S709 in FIG. 7.

### Example 3

In example 3, the waiting time between forward printing and backward printing is calculated, although the carriage movement width is increased in step S706 in FIG. 7 in example 1. Before or after step S708 in FIG. 7, processing of stopping for the calculated waiting time is included. When the waiting time is assumed to be Twait, it is sufficient to wait for the time Twait that satisfies the following expression.

$$( Wp + Wn ) / Vcr + 3 Vcr / a + Tlf + ( ( Wp + Wm - Wc ) + Wn ) / Vcr + Twait \geq Twp + m$$

### Example 4

In example 4, processing of step S706 in FIG. 7 is performed by combining two or more of examples 1 to 3. In example 1, since the carriage is moved at least the image width, the time during which no ink is ejected increases. By properly increasing the carriage movement range, it is possible to suppress thickening and sticking of ink inside of nozzles caused by an increase in the time during which no ink is ejected. Although example 2 has the limitation that the carriage speed cannot be set to an arbitrary value, it is possible to suppress changes in image quality with respect to a portion printed at a normal carriage speed due to a change in the carriage speed during printing by appropriately reducing the carriage speed. In example 3, the time during which no ink is ejected increases as in example 1. By properly setting a carriage stop period, thickening and sticking of ink can be suppressed.

The value after the change of the carriage movement width is set to Wrp, the value after the change of the carriage speed is set to Vrer, the waiting time is set to Twait, and each value is adjusted such that thickening and sticking of ink and change in the image quality are suppressed and the following expression is satisfied.

$$( Wrp + Wn ) / Vrcr + 3 Vrcr / a + Tlf + ( ( Wrp + Wm - Wc ) + Wn ) / Vrcr + Twait \geq Twp + m$$

While the examples in which the liquid ejection apparatus of the present invention is applied to a recording device that records an image by ejecting ink onto a recording medium have been described, the present invention is not limited to the recording device and can be applied to various liquid ejection apparatus such as a dispenser that ejects a liquid to an object. In the above examples, the recording medium is an example of an object to which a liquid is ejected. Further, the image forming operation is an example of a forming operation of ejecting a liquid to an object. The ink is an example of a liquid. The present invention can be applied to a liquid ejection apparatus that ejects a liquid from an ejection opening provided in a head while moving a carriage in a main scanning direction with respect to an object. The liquid is not limited to the ink, and may be a substance in a liquid phase that can be ejected from the ejection opening of the head toward an object. For example, the liquid may be liquids of various viscosities, sols, gels, solvents, solutions, liquid resins, liquid metals, liquids in which solid particles such as pigments or metal particles are dissolved, dispersed, or mixed in a solvent, and the like.

In the liquid ejection apparatus that performs a head wiping operation using a wiping mechanism, a time required to perform a wiping operation following a forming operation of ejecting a liquid to an object can be shortened.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-066205, filed on Apr. 16, 2024, which is hereby incorporated by reference herein in its entirety.

What is claimed is:

1. A liquid ejection apparatus comprising:
a head provided with an ejection opening for ejecting a liquid;
a carriage on which the head is mounted; and
a wiping mechanism configured to perform a wiping operation to wipe an ejection surface of the head on which the ejection opening is provided while moving relative to the carriage;
wherein the liquid ejection apparatus is configured to perform a forming operation of ejecting the liquid from the ejection opening to an object while moving the carriage in a main scanning direction with respect to the object,
wherein the carriage is movable to a formation position for performing the forming operation and a wiping position for performing the wiping operation, and
wherein the wiping mechanism is movable to a standby position, a start position at which the wiping operation is started, and an end position at which the wiping operation ends; is configured to perform the wiping operation by moving from the start position to the end position in a state in which the carriage is at the wiping position after moving from the standby position to the start position; performs a preparation operation for preparing the wiping operation in the standby position; and performs the preparation operation and movement from the standby position to the start position in parallel to the forming operation when performing the wiping operation following the forming operation.

2. The liquid ejection apparatus according to claim 1,
wherein the wiping mechanism comprises:
an absorption member configured to absorb the liquid and wipe off the liquid from the ejection surface by being pressed against the ejection surface; and
an application member configured to apply a cleaning solution to the absorption member, and
wherein the preparation operation includes an operation in which the application member applies the cleaning solution to the absorption member.

3. The liquid ejection apparatus according to claim 1,
wherein the carriage is configured to collide with the wiping mechanism at a collision position during the forming operation if the wiping mechanism is at a position between the standby position and the start position, and
wherein adjustment is performed to increase a time for the forming operation such that the carriage reaches the collision position after the wiping mechanism reaches the start position.

4. The liquid ejection apparatus according to claim 3, wherein the adjustment is to make a range of movement of the carriage in the main scanning direction larger than a predetermined range of movement.

5. The liquid ejection apparatus according to claim 4,
wherein the forming operation is a recording operation of recording an image on a recording medium, and
wherein the predetermined range of movement of the carriage is a range of movement determined depending on a width of the image in the main scanning direction.

6. The liquid ejection apparatus according to claim 3, wherein the adjustment is to change a predetermined parameter related to a speed of movement of the carriage to increase a time for the carriage to move through the predetermined range of movement in the main scanning direction.

7. The liquid ejection apparatus according to claim 6,
wherein the forming operation is a recording operation of recording an image on a recording medium, and
wherein the predetermined parameter related to the speed of movement of the carriage is a parameter set according to a recording mode related to quality or speed of recording of the image.

8. The liquid ejection apparatus according to claim 6,
wherein the parameter is a speed of the carriage moving at a constant speed, and
wherein the adjustment is to decrease the constant speed of the carriage to a speed below the predetermined speed.

9. The liquid ejection apparatus according to claim 3, wherein the adjustment is to provide a stop period during which the liquid is not ejected during the forming operation.

10. The liquid ejection apparatus according to claim 3, wherein the adjustment is performed by combining:
increasing a range of movement of the carriage in the main scanning direction to be greater than a predetermined range of movement;
changing a predetermined parameter relating to a speed of movement of the carriage to increase a time for the carriage to move through the predetermined range of movement in the main scanning direction; and
providing a stop period during which the liquid is not ejected during the forming operation.

11. The liquid ejection apparatus according to claim 1,
wherein the wiping mechanism has a receiving part configured to receive, at the end position, the liquid ejected from the head of the carriage at the wiping position, and
wherein after the wiping operation ends, preliminary ejection is performed to eject the liquid from the head to the receiving part.

12. The liquid ejection apparatus according to claim 1,
wherein the forming operation of ejecting the liquid from the ejection opening while moving the carriage relative to the object in the main scanning direction and a conveying operation of moving the object in a sub-scanning direction intersecting the main scanning direction are performed repeatedly a plurality of times so as to eject the liquid to an area of the object that exceeds a size of the head in the sub-scanning direction, and
wherein the wiping operation is performed following at least one of the plurality of forming operations.

13. The liquid ejection apparatus according to claim 1, wherein a moving direction of the wiping mechanism is parallel to a sub-scanning direction intersecting the main scanning direction.

14. The liquid ejection apparatus according to claim 1, wherein the wiping operation is performed in a case where a cumulative ejection amount of the liquid after previous execution of the wiping operation is a threshold value or more.

15. The liquid ejection apparatus according to claim 1, wherein the wiping operation is performed when a predetermined time has elapsed since previous execution of the wiping operation.

16. A method of controlling a liquid ejection apparatus,
wherein the liquid ejection apparatus comprising:
a head provided with an ejection opening for ejecting a liquid;
a carriage on which the head is mounted; and
a wiping mechanism configured to perform a wiping operation to wipe an ejection surface of the head on which the ejection opening is provided while moving relative to the carriage, and
wherein the method of controlling the liquid ejection apparatus comprising:
causing the wiping mechanism to wait at a standby position;
performing in parallel:
a forming operation of ejecting the liquid from the ejection opening while moving the carriage in a main scanning direction with respect to an object at a formation position; and
a preparation operation of preparing for the wiping operation and an operation of moving the wiping mechanism from the standby position to a start position for starting the wiping operation;
moving the carriage to a wiping position for performing the wiping operation by the wiping mechanism following the forming operation; and
wiping the ejection surface by moving the wiping mechanism from the start position to an end position at which the wiping operation ends in a state in which the carriage is at the wiping position.

17. The method of controlling a liquid ejection apparatus according to claim 16,
wherein the carriage is configured to collide with the wiping mechanism at a collision position during the forming operation if the wiping mechanism is at a position between the standby position and the start position,
wherein the method further comprises performing adjustment to increase a time for the forming operation such that the carriage reaches the collision position after the wiping mechanism reaches the start position.
